(19) United States
(12) Patent Application Publication
(10) Pub. No.: US 2026/0228610 A1
(43) Pub. Date: Aug. 6, 2026

(54) SYSTEMS AND METHODS FOR SEARCH MACHINE LEARNING

(71) Applicant: DISH Network L.L.C., Englewood, CO (US)

(72) Inventors: Abhishek Nichat, Aurora, CO (US); Sravani Gonuguntla, Parker, CO (US); Sarah Nguyen, Aurora, CO (US); Gurkiranjot Singh, Denver, CO (US); Yong-Joon Oh, Morgan Hill, CA (US)

(21) Appl. No.: 19/045,256

(22) Filed: Feb. 4, 2025

(51) Int. Cl. G06N 20/00; G06Q 30/08

(52) U.S. Cl. CPC G06N 20/00; G06Q 30/08

(57) ABSTRACT

Techniques for allocating digital resource, including: generating, based on a machine learning model, a predicted feature of a user by inputting a representation of a user profile of the user into the machine learning model, wherein the machine learning model is generated by: receiving, by a processor, user data from a database; generating, by the processor, a first training set by extracting multi-dimensional feature representations from historical online engagement activities of the plurality of sample users; training a machine learning model in a first stage using the first training set to generate initial classification boundaries for user interest prediction; automatically detecting classification errors; constructing a second training dataset based on the first training set with the identified classification errors; and retraining the machine learning model using the second training dataset; and executing a real-time digital resource allocation operation based on the predicted feature of the user.

### BACKGROUND

Currently, vendors rely on ad bidding platforms to bid on particular advertisements for particular customers based on limited information. The vendors rely on these ad bidding platforms to bring them new customers. Such ad bidding platforms are blind to whether or how the customers actually bring value to the vendors.

### SUMMARY

One aspect of the present document relates to a method for allocating digital resource. The method includes: generating, based on a machine learning model, a predicted feature of a user by inputting a representation of a user profile of the user into the machine learning model, wherein the machine learning model is generated by: receiving, by a processor, user data from a database; generating, by the processor, a first training set by extracting multi-dimensional feature representations from historical online engagement activities of the plurality of sample users; training a machine learning model in a first stage using the first training set to generate initial classification boundaries for user interest prediction; automatically detecting classification errors; constructing a second training dataset based on (e.g., by combining) the first training set with the identified classification errors; and retraining the machine learning model using the second training dataset; and executing a real-time digital resource allocation operation based on the predicted feature of the user. In some embodiments, automatically detecting classification errors may include identifying, from the plurality of sample users, a first subset of users incorrectly classified as interested based on digital engagement metrics; and/or identifying, from the plurality of sample users, a second subset of sample users incorrectly classified as uninterested based on digital engagement metrics.

One aspect of the present document relates to a method for performing an online real-time advertisement auction. The method includes: obtaining, at a bid adjustments processor, a machine learning model trained to predict bid amounts based on multi-faceted user profiles of sample users; receiving, during an active advertising campaign, information about an available advertisement slot with respect to a prospective user on a webpage, search results page, or in an application; determining, by the bid adjustments processor using the machine learning model, a bid amount for the slot by inputting a representation of a user profile of the prospective user to the machine learning model; and participating in a real-time auction for the slot by transmitting the bid amount to an advertisement platform.

A further aspect of the present document relates to a system for allocating digital resource. The system includes a processor and a memory storing instructions that, when executed by the processor, cause the system to perform operations similar to the method described above. In some embodiments, the allocation of digital resource may include or relate to real-time advertisement auction online.

A still further aspect of the present document relates to one or more tangible, non-transitory, machine-readable media storing instructions that, when executed by one or more processors, cause the one or more processors to perform operations for allocating digital resource, similar to the method described above. In some embodiments, the allocation of digital resource may include or relate to real-time advertisement auction online.

Those and other implementations are described in greater detail in the drawings, the description and the Claims.

### BRIEF DESCRIPTION OF THE DRAWINGS

FIG. 1 is a schematic diagram showing the computed value of three types of customers for an organization, according to some embodiments.

FIG. 2 is a schematic diagram illustrating an example of value bidding, according to some embodiments.

FIG. 3 is a block diagram illustrating components which, in some implementations, can be used in a system employing the disclosed technology.

FIG. 4 is a table showing the results of tCPA and tROAS for three billing cycles, according to some embodiments.

FIG. 5 is an example lookup table used to determine present values of users during an auction, according to some embodiments.

FIG. 6 is an architectural diagram for the high value customer prediction model, according to some embodiments.

FIG. 7 is an example lookup table used to determine present values of users during an auction, according to some embodiments.

FIG. 8A illustrates a flowchart of a process for allocating digital resource, according to some embodiments.

FIG. 8B illustrates a flowchart of a process for generating a machine learning model used in digital resource allocation, according to some embodiments.

FIG. 9 illustrates a flowchart of a process for performing real-time advertisement bidding, according to some embodiments, according to some embodiments.

FIG. 10 is a block diagram illustrating an overview of devices on which some implementations of the disclosed technology can operate.

FIG. 11 is a block diagram illustrating an overview of an environment in which some implementations of the disclosed technology can operate.

FIG. 12 is a block diagram illustrating components which, in some implementations, can be used in a system employing the disclosed technology.

FIG. 13 is an AI architecture, according to some embodiments.

### DETAILED DESCRIPTION

Various examples of the systems and methods introduced above will now be described in further detail. The following description provides specific details for a thorough understanding and enabling description of these examples. One skilled in the relevant art will understand, however, that the techniques and technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

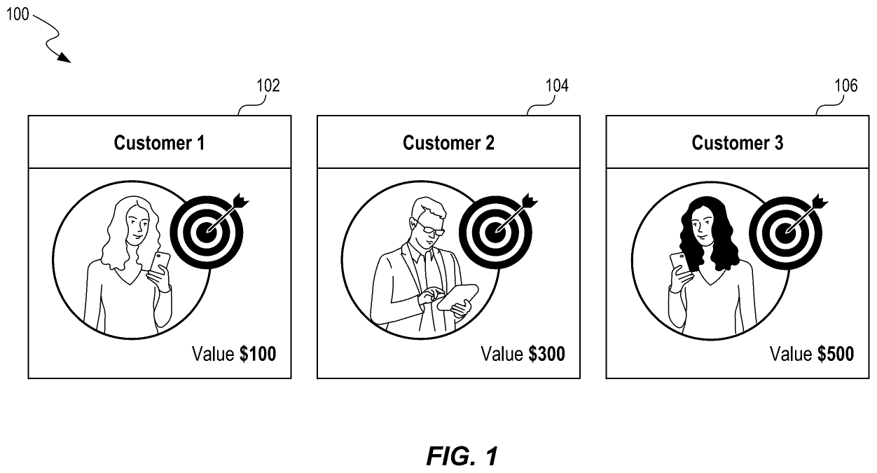

One current methodology for advertising can be understood with reference to FIG. 1. FIG. 1 is a schematic diagram 100 showing the computed value of three types of customers for an organization, according to some embodiments. For example, a first customer 102 is valued at $100; a second customer 104 at $300; and at third customer 106 at $500. That illustrates that not every customer brings the same value to a business or organization. Some conversions do not matter as much to a business' goals, while others are of higher value and should be reported and optimized for accordingly. In the example, it would be advantageous for such organization to look for customers like Customer 3 versus Customer 1 or Customer 2.

It should be appreciated that conversion as used herein can mean a defined goal for one's business. For instance, in the streaming industry a conversion can be a purchase of a subscription to the streaming of content service. Another meaning consistent with embodiments herein is a revenue that generates activity for that potential customer. E.g., a conversion can be a service that leads to a higher dollar value revenue versus a lower dollar value revenue.

Thus, the present document introduces systems and methods (also referred to herein as a “system” or “systems”) that are configured for value-based bidding. In some embodiments, the system configured for value bidding reaches a higher value customer through an improved bidding system on online advertising platforms, such as but not limited to Google Ads (by Google, Mountain View, California), Microsoft Advertising (by Microsoft, Redmond, Washington), and Meta Ads (by Meta, Menlo Park, California). The system allows an organization to maximize its budget to acquire high value customers and the way the value of a customer is determined is innovative. Further, embodiments herein are configured to be customizable so that each business can value their customers according to their objectives. Thus, consistent with embodiments herein, for Company A, a person could be worth (e.g., expected to generate, for Company A, a revenue of) X amount of dollars; according to Company B's configuration, the person would be worth (e.g., expected to generate, for company B, a revenue of) a different amount. The computed values are based on different, specific variables, which are described in detail below. In some embodiments, the dollar value is measured over a time frame. For example, the revenue can be a monthly subscriber revenue, annual subscriber revenue, etc.

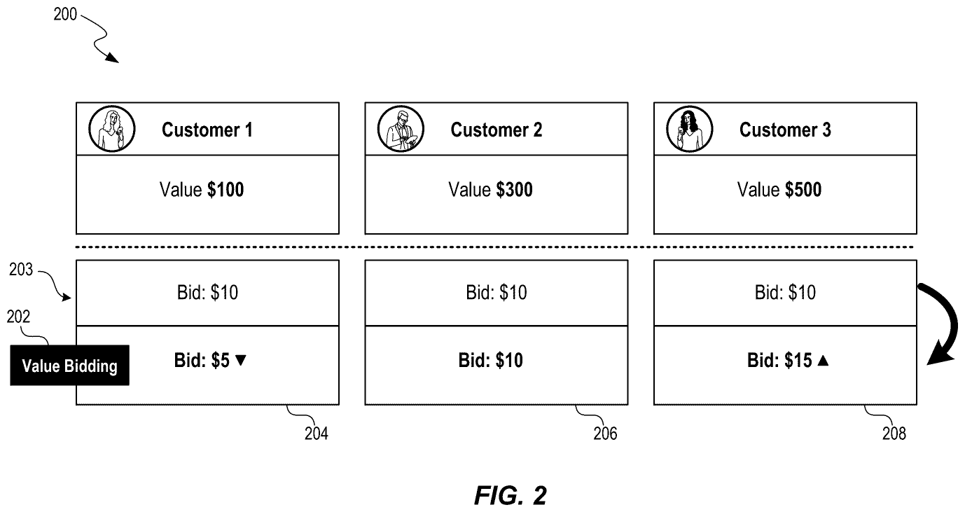

Some embodiments can be understood with reference to FIG. 2. FIG. 2 is a schematic diagram illustrating an example of value bidding 200, according to some embodiments. According to the existing model, each of first customer 102, second customer 104, and third customer 106 has a bid value 203 of $10. However, in accordance with embodiments herein, the system in this example computes different bid values based on their respective values as customers. The computed first bid value 204 for first customer 102 is $5; the computed second bid value 206 for second customer 104 is $10; and the computed third bid value 208 for third customer 106 is $15. Such three computed different values are illustrative of value bidding 202, as described herein. FIG. 2 illustrates how with value bidding 202, a company can maximize and optimize its budget to acquire higher value customers. With value bidding, an organization can spend its marketing budget to reach higher value customers.

Consistent with embodiments herein, value-based bidding brings values into bidding platforms, such as for example, Smart Bidding by Google. Smart Bidding is an automated bidding strategy that uses real-time signals and machine learning technology to drive sales. With the system as disclosed herein adding value-based bidding to Smart Bidding, an organization can improve or maximize their conversion value and return on investment (ROI). Consistent with embodiments herein, the system is configured to differentiate customers and to bid on what matters, to drive increased performance. Presently, while advertisers might internally differentiate their customers' value, they do not share this information with advertising platforms, such as Google, for optimization. As such, organizations (e.g., vendors, advertisers) bid on all matters non-discriminatorily. In contrast, with the value bidding technology, the system learns which potential customers are most valuable to the advertisers. Bidding towards the most valuable customers can deliver incremental revenue uplift and profitability to advertisers. An Exemplary Targeted Return On Ad Spend and Customer Lifetime Value Embodiment

Presently, a media team may translate a desired return on marketing investment (ROMI) into a cost per acquisition (CPA). The methodology targets per category, based on learned assumptions about the average customer lifetime value (CLV) that each category tends to drive. Examples of categories include, but are not limited to, sports channels (e.g., the National Football League (NFL) channel), college football channels, or their adult animation channels. The Google Ads system computes its bids in order to achieve that desired CPA—it does not take CLV into account. In practice, the media team waits and observes the CLV driven by marketing activity, and uses that CLV value to hone future CPA targets at the category level. It has been found that there are complexities to the CLV of users within categories, that currently can only be addressed via segmentation. Over-segmentation can negatively impact the efficiency and accuracy of the corresponding machine learning.

An example of over-segmentation negatively impacting machine learning is as follows. Within an NFL advertisement campaign there can be bidding on multiple things including, e.g., football generic terms, NFL generic terms, and team terms. A customer can come to the business through the red zone. For purposes of discussion herein, the red zone is a program where customers (or referred to as users) can watch the highlights of the NFL football games. It is an add-on package that people have to purchase to watch. That customer is worth (e.g., expected to generate, for the advertiser (or referred to as vendor), a revenue based on a subscription to) a base package plus an add-on. Such a customer is worth more than another person coming in on (e.g., converting on or purchasing/subscribing to) a regular package. They could come through football generic terms, NFL generic terms, and team terms, for instance. Thus, the space is very segmented (e.g., segmented into football generic terms, NFL generic terms, and team terms). This is how or where the over-segmentation can hurt the outcome for the vendor with machine learning, when the model is significantly segmented and the audience (or the training data available) for each category is significantly small.

In contrast, the system herein eliminate the need for the segmentation approach discussed above. According to embodiments herein, customers can be coming in on any advertisement (ad) on the Targeted Return On Ad Spend (tROAS) platform, e.g., advertisements that may fall under categories such as NFL generic terms, team terms, football generic terms, or other related groupings. The system then predicts their respective values based on their interaction.

Consistent with embodiments herein, ad spend is defined as follows. A vendor can have marketing dollars that are designated to be spent on specific ads. Ad spend effectiveness then is measured by the return on ad spend (ROAS), which represents the revenue generated (or received by the vendor) on the amount of dollars invested in their marketing efforts.

An example of present day use of CLV is as follows. Suppose a vendor has an ad that is intended to run on the NFL channel. The vendor may have worked with their finance team to calculate generally the lifetime value of someone coming from an NFL ad. The vendor can track if the customer came from the NFL ad campaign using a unique Google click identifier (GCLID). In the example, they are going to be an NFL customer and based off of that, the current methodology can predict the NFL customer is going to last as a customer for a predetermined amount of time. The vendor assumes for this type of customers that they are going to drive a certain amount of revenue to the vendor's business. For instance, assume a person comes in through a team and can only watch a few games. Perhaps they get upset that they do not have access to all of the team's games and they leave as customers. According to a targeted cost per acquisition (tCPA) model, such customers coming in through the team are all treated the same as customers coming in through other terms including, e.g., a different team, NFL generic terms, etc.; the CLV of all these customers is considered the same.

In contrast, in accordance with embodiments herein, the different variables within these themes that cause them to have a higher or lower CLV are taken into consideration. For instance, the system as disclosed herein may have learned from prior data and estimate that someone watching News along with NFL content and not watching Comedy can have a higher CLV than someone exclusively watching NFL content.

According to some embodiments herein, the system is configured to provide CLV targets for past converters to ad bidding platforms or systems, for example but not limited to Google's Smart Bidding. The technology enables such platforms to learn which users (or referred to as customers) are likely to drive specific CLV. By using embodiments configured to set return on ad spend (ROAS) targets in a program that recognizes CLV, the cost-per guesswork involved in driving ROMI is alleviated or removed. That is, the vendor's systems and ad bidding platforms can utilize a methodology that incorporates machine learning to optimize towards ROMI.

Moreover, embodiments herein enable complexities within categories to be solved programmatically. That is, as opposed to choosing an average CPA for prospective customers (or referred to as users) of different categories, or segmenting the campaigns to target prospective customers of different categories to solve for that complexities, embodiments herein are configured to enable the ad bidding platform (e.g., Google's systems) to learn to recognize and incorporate such CLV differences on a user by user basis.

### Viewership Data Monitoring.

The system as disclosed herein operates without regard to the category through which a customer came to the business of the vendor. For instance, according to embodiments herein, it does not matter if the customer came through the vendor's NFL channel, their college football channel, or their adult animation ads. Such a customer can come from any of the categories. Instead, the system is configured to monitor viewership data. For instance, the customer could have been watching the news, adult animation, or the NFL. Embodiments herein are configured to gather information about the entirety of their viewership and process such information to predict how long they will remain as customers, such as, for example, past the third billing cycle. For instance, the system is configured to determine, after the third billing cycle, e.g., after three months, whether the customer is still with the vendor, and still a revenue generating customer. Further embodiments herein are configured to predict whether the customer remains past the 4th, 5th, etc., billing cycles, in accordance with iterations of the model disclosed herein.

Thus, embodiments herein enable bidding towards the customer's value (e.g., the vendor's estimated revenue from the customer), instead of bidding based on the customer's acquisition channel, such as a channel event or a singular cohort, such as, for example, a channel event or a singular cohort. That is, in the existing methodology of targeted CPA, a vendor may assign a fixed estimated revenue value of $50 to a customer, although the customer may actually generate $100 in revenue for the vendor by maintaining a longer subscription period. However, in the existing methodology, because they came in through a category of the vendor's business, they are assigned a predetermined revenue value, e.g., $50. In contrast, in accordance with embodiments herein, the system can determine their actual value (e.g., the vendor's actual revenue from the customer), which may differ from the predetermined revenue value used for bidding in the prior methodology.

In some embodiments, the tROAS+CLV mechanism (referred to herein also as the tROAS+CLV model or system) is added to the existing tCPA mechanism (referred to herein also as the tCPA model or system). That is, the system disclosed herein determines or acquires a cohort with the price based on which the tROAS was based. Examples of such cohorts (or referred to as groups) include News, NFL, CFB, NBA, Entertainment, etc. The system disclosed herein keeps that same tROAS structure, but adds in the CLV model portion within that cohort and determines which individuals are considered the high CLV versus the low CLV, or their CLV in general. By this methodology, a bidding configuration bids towards value versus treating everybody coming through within the same category as the same.

### Efficiencies

The embodiments described above remove or reduce the uncertainty in determining acquisition costs for users. Thus, the system disclosed herein may decline to bid on users predicted to generate low revenue for the vendor. This optimization can be scaled across multiple business units within the vendor's organization. When considering millions of bids placed globally, this reduction in unnecessary bids significantly decreases processing costs, server utilization, and data transmission across networks. These factors directly impact the performance of users, vendors, and network infrastructure. Thus, the system disclosed herein improves e-commerce technology by reducing computational overhead and processing costs in the bid campaign, ultimately leading to a more efficient bidding process. By enabling vendors to identify and target prospective customers more precisely, the approach disclosed herein can substantially reduce bid frequency, thereby conserving computational resources and optimizing the bidding process for improved vendor performance.

### An Example Embodiment of the Integration of Machine Learning to Predict CLV Calculations for Dynamically Adjusting Bid Strategies

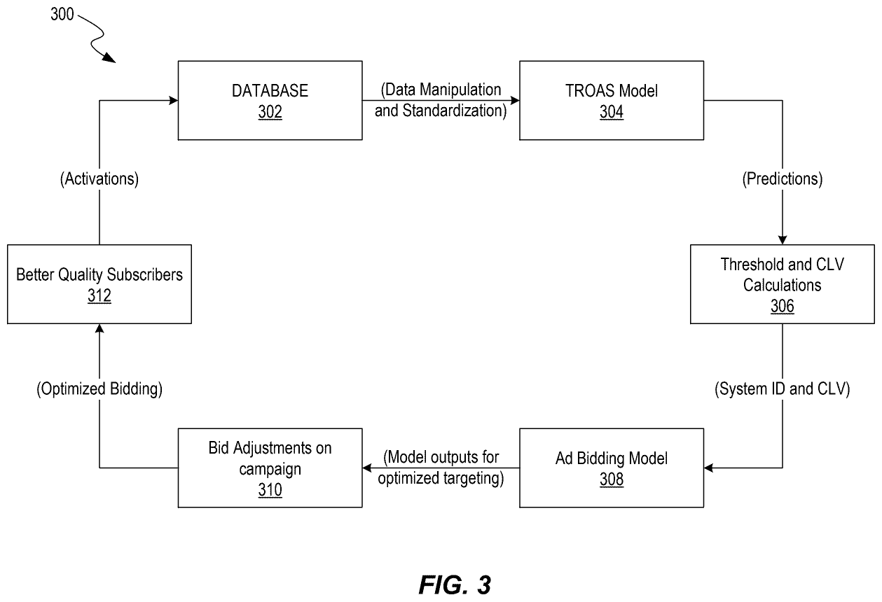

In some embodiments, the technical solution improves hardware and network resource efficiency by reducing processing overhead, server load, and network data transmission in bid processing. The system so determined may optimize the vendor's spend, reduce the churn of customers, and obtain better engagement with customers that increases the stickiness for the platform or the lifetime of the customer for the vendor. The system has a hybrid architecture that combines offline model training with real-time advertisement bidding optimization. The technical implementation can be understood with reference to FIG. 3. FIG. 3 is an architectural diagram 300 for value-based prediction system 300 (“system 300”), according to some embodiments of the present disclosure. The system 300 includes computing customer revenue predictions, training the ad bidding model using the computed predictions, and implementing resource-optimized bidding processes according to some embodiments of the present disclosure.

In some embodiments, a vendor database 302 is provided that stores historical customer data. The database 302 may operate as an offline component of the system 300. Examples of customer data include but are not limited to customer identifiers (IDs), transaction histories (including, e.g., their particular purchased products or services from the vendor), engagement duration metrics (including, e.g., how long they have been a customer of the vendor), advertisement interaction data (including, e.g., the websites visited that served the vendor's ads), viewership data (including, e.g., vendor accounts watched and duration of watching such accounts, genres of broadcasting data), and customer segment data. The customer segment data may include data of customers of a same segment (or referred to as category, cohort, or group). For example, for a vendor like Sling or DISH, customer segment data may include viewership data for NBA cohort, News cohort, etc.

At the vendor database 302, certain data manipulation and/or standardization functionality are performed to format the historical customer data for input into a tROAS model 304. As opposed to the online live advertisement bidding process, the tROAS model 304 may operate as an offline component of the system 300. The tROAS model 304 analyzes the formatted historical customer data described above and outputs customer predictions. Examples of such predictions include but are not limited to projected customer retention periods (e.g., how long a particular customer will remain a customer) and expected revenue generation patterns (e.g., how much revenue the particular customer can be expected to produce). For instance, a prediction can indicate a three-billing-cycle retention period with projected revenue of $500 for a specific customer. Such predictions from the offline analysis are input into a threshold and CLV calculations processor (or referred to as “CLV calculations processor” for brevity) 306.

The CLV calculations processor 306 generates a CLV mapping dataset including system identifiers paired with corresponding CLV metrics. The CLV calculations processor 306 may operate as an offline component of the system 300. For example, the system identifiers include Google Click IDs (GCLIDs), which are Google Ads' unique identifiers for tracking customer interactions. The CLV metrics can be represented in several forms: as absolute monetary values corresponding to the generated or expected revenues (e.g., Customer 1 with $100, Customer 2 with $300, and Customer 3 with $500), as value-based groupings (e.g., categorizing Customer 3 as high-value, Customer 2 as medium-value, and Customer 1 as low-value), or as numerical scores based on CLV ranges. The grouping or scores may be determined based on one or more CLV thresholds. The CLV mapping dataset, which incorporates historical customer data—including their corresponding CLV representations—is utilized to train the ad bidding model 308.

The vendor may define one or more CLV thresholds to analyze customer profiles. As an illustration with reference to the example illustrated in FIG. 1, the vendor may specify that a CLV threshold of $300 to classify a customer as a desirable target or not. This threshold may be used in training the ad bidding model 308 based on historical customer data, or the application thereof for live ad bidding where the model 308 evaluates the expected CLV of prospective customers.

The ad bidding model 308 is trained using the CLV mapping dataset including historical customer data. This training process can be performed offline. The training can employ either a weighted or unweighted approach, depending on the specific goals of the ad campaign and the characteristics of the customer base. The ad bidding model 308 may be trained to operate as a classifier to determine whether a prospective customer is a desirable target for an advertisement. Additionally, or alternatively, the model 308 may generate a predicted CLV for the prospective customer, which can be used for further analysis, such as providing feedback to refine and update the model 308.

In weighted training, data from customers with higher CLVs (such as Customer 3) are assigned greater weight compared to customers with lower CLVs (such as Customer 2). Both Customers 2 and 3 are considered desirable customers (e.g., based on a CLV threshold the vendor has specified); however, Customer 3's profile, due to its higher CLV, is given greater weight than Customer 2's profile during training. In contrast, Customer 1, who has the lowest CLV among the three, is classified as a customer to avoid in ad bidding. Customer 1's profile is included in the training data to help the model recognize patterns associated with undesirable customers. The model 308 may function as a classifier, trained to distinguish between desirable customers (e.g., Customers 2 and 3) and customers to avoid (e.g., Customer 1), enabling the ad bidding system to prioritize high-value customers effectively.

The alternative approach trains the model 308 without assigning explicit weights based on CLVs. Instead, the model 308 learns to naturally associate customer profiles with their corresponding CLV levels through pattern recognition in the training data. For example, the model learns that profiles sharing characteristics with Customer 3 tend to have CLVs around $500, while profiles similar to Customer 1 tend to have CLVs around $100. This method allows the model 308 to develop an inherent understanding of the relationship between customer characteristics and value levels.

Under either training approach, the ad bidding model 308 functions as a classifier that can categorize potential customer profiles into multiple classes based on their predicted value levels. For instance, the model may classify prospects into two classes: a first class including profiles of preferred customers predicted to generate higher CLVs (e.g., profiles sharing characteristics with Customers 2 and 3) and a second class including profiles of customers predicted to generate lower CLVs, who may be excluded from advertisement campaigns (e.g., profiles similar to Customer 1). This classification helps processor 310 make efficient real-time bidding decisions by quickly identifying which prospects are likely to become high-value customers.

Alternatively, the model 308 may be trained to classify prospects into three or more groups such as very high value (e.g., profiles similar to Customer 3), high value (e.g., profiles similar to Customer 2), moderate value, low value (e.g., profiles similar to Customer 1), and very low value. The classification may also be based on predicted CLV ranges (e.g., >$300, between $200 and 300, between $100 and 200, or <$100).

The model 308 outputs optimized targeting data that includes these multiple classifications, enabling processor 310 to implement more nuanced bidding strategies. For example, it may bid aggressively on very high value prospects, moderately on high value prospects, conservatively on moderate value prospects, and potentially exclude low or very low value prospects from the campaign. This multi-class classification allows for more granular and sophisticated targeting decisions during real-time bidding.

The bid adjustments processor 310 represents an online component of the system 300, implementing real-time bidding decisions during active advertising campaigns. When an ad slot becomes available on a webpage, search results page, or in an app, processor 310 determines, using the trained model 308, how much to bid in the real-time auction for showing an advertisement in that slot to a particular prospective customer. The bid amount represents the maximum price the vendor is willing to pay for winning that ad impression in the auction. Higher bids increase the likelihood of winning the auction and having the advertisement displayed to that prospect. The bidding amount may be determined based on how closely the prospect's profile matches the characteristics of known high-CLV customers identified during the offline training. For prospects whose profiles closely match those of high-CLV customers, the system places higher bids to increase the chances of winning the ad auction and reaching these potentially valuable customers.

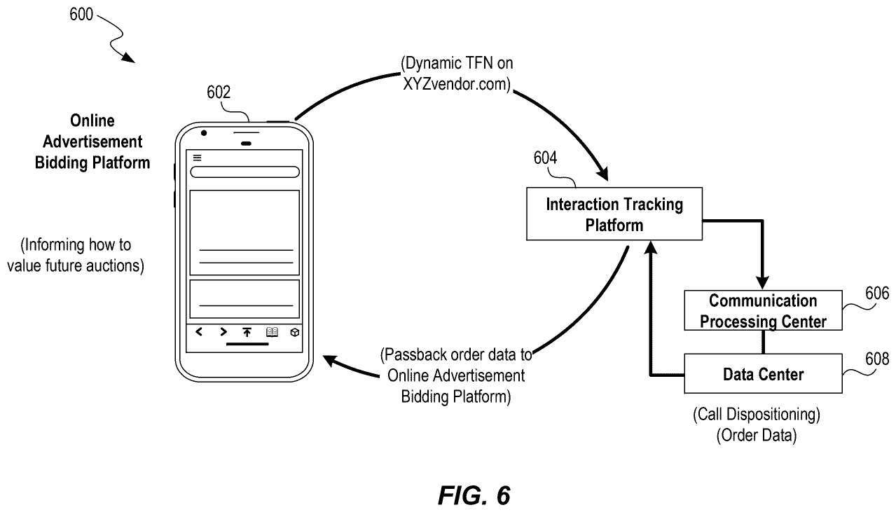

During live ad campaigns, processor 310 evaluates prospective customers by comparing their profiles (including demographic information, browsing behavior, interests, etc.) against the profiles of known high-CLV customers identified during offline training using the model 308. When there is a strong profile similarity to high-CLV customers, the system 300 identifies these prospects as valuable targets and adjusts bidding strategies accordingly. The better quality customers processor 312 monitors and analyzes the performance of these targeting and bidding decisions, collecting data about which targeted prospects actually convert into customers and their subsequent behaviors. This processor 312 transmits activation data back to the vendor database 302, completing the feedback loop between the online bidding system and the offline training components. The activation data includes customer engagement metrics such as ad click-throughs, conversion rates, and post-conversion behaviors, which are used to update the offline training data and further refine the model's ability to identify high-value prospects. The vendor database 302 incorporates this real-world performance data to update its records (e.g., lookup table as illustrated in FIG. 5), which may be used in the next cycle of offline model training to improve future bidding strategies.

In some embodiments, the offline components (302, 304, 306, and 308) work together to create and continuously (periodically, triggered by an event (e.g., data availability), or pursuant to user instructions) improve the predictive model used in real-time bidding. The vendor's tROAS model 304 is initially trained using historical customer data to predict retention probability and expected revenue. These predictions feed into the CLV calculations processor 306, which generates the training data used to teach the ad bidding model 308 how to identify potentially valuable customers. This trained model 308 is then deployed to guide the real-time bidding decisions made by processor 310 during active campaigns.

For illustrative purposes, consider a scenario where a desired revenue generation is five times the advertising expenditure. The tROAS calculation may be represented as: (Projected Revenue+Advertising Expenditure)×100=tROAS Percentage. In other words, ($5 USD=$1 USD)×100=500% tROAS.

The advertising platform's bid management system then implements an optimization algorithm configured to adjust bidding parameters dynamically, with the objective of improving or maximizing conversion value while maintaining the specified tROAS ratio. This approach allows for precise control and optimization of advertising spend across digital marketing platforms.

During online operation, bid adjustments processor 310 applies the trained model 308 to make real-time bidding decisions, while processor 312 collects performance data from these live campaigns. The vendor electronically tracks and processes user interaction data through automated data collection interfaces, including media consumption metrics (such as accessed content channels, viewing duration timestamps, and content category identifiers). The vendor further captures digital interaction metrics from live campaigns, including advertisement link activations, webpage session durations, and navigation path analysis. These interaction metrics are automatically collected and processed through the vendor's digital tracking interfaces and data processing modules for use in subsequent offline training cycles. This creates a continuous improvement loop where the offline components (302, 304, 306, and 308) use real campaign performance data to refine the model, which in turn improves the online bidding decisions made by processor 310. The training data evolves to include both initial predictions and actual performance data, allowing each training cycle to produce more accurate models for identifying high-value prospects.

For example, a first training set is created for training the model 308. The CLV calculations processor 306 creates the initial, first training set by compiling historical customer data, including, e.g., credit score, a categorization of geographical areas, a categorization of product or service packages or tiers, and activation data. The model 308 is trained in a first stage using the first training set. It is the first stage data that are used as input to the bid adjustments processor 310, which outputs the high-value audiences (or prospect) and de-prioritizes low-value audience (or prospect) segments for targeted advertisement placements. Once new customers are acquired, their order value (value they have brought in) may be collected by 312 and then to 302. The database 302 and the tROAS model 304 creates a second (or subsequent) training set for a second (or subsequent) stage of training. The second training set includes but is not limited to the first training set and updated user demographic information, known user purchase history subsequent (e.g., in response to) the targeted advertisements, and four variables: credit score, a categorization of geographical areas, a categorization of product or service packages or tiers, and activation data that indicate corrections to the first training set. Then the machine learning model is trained in a second (or subsequent) stage using the second (or subsequent) training set.

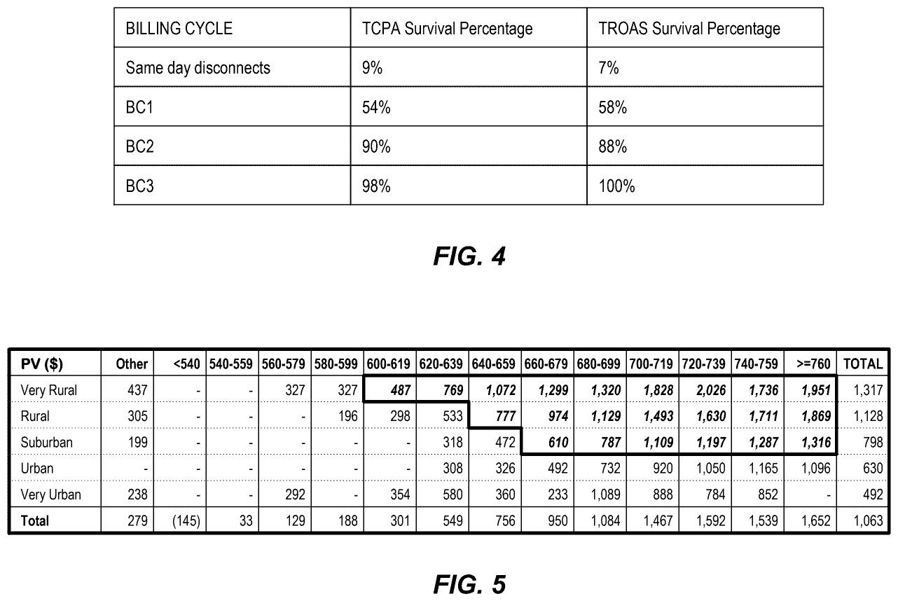

FIG. 4 is a table showing the results of tCPA and tROAS for three billing cycles of a service subscription, according to some embodiments. The results show an approximate three percent (3%) improvement of the model disclosed herein (e.g., tROAS) over TCPA for the first billing cycle (BC1) and second billing cycle (BC2). As illustrated in FIG. 4, for customers selected by the tROAS model, the same-day service disconnection rate is 7%, compared to 9% for customers selected by the tCPA model. The results of the retention analysis across billing cycles include: at billing cycle 1 (BC1), the survival rate is 58% for the tROAS model versus 54% for the tCPA model; at BC2, the retention rate is 88% for the tROAS model versus 90% for the tCPA model; at BC3, the retention rate is 100% for the tROAS model versus 98% for the TCPA model.

Table 1 below is another example showing comparison between tCPA model and tROAS model. As illustrated in Table 1, assuming 100 subscribers are acquired from Target CPA and Target ROAS bid strategy on the same day. The below table shows the customers that survived post 3^{rd} billing cycle for each of the bid strategies. Out of 100 customers, 47 survive from customers acquired through Target ROAS post 3^{rd} billing cycle whereas 43 customers survive for Target CPA bid strategy, indicating that there is a 4% improvement when using Target ROAS bidding strategy.

| Survival Till 3rd Billing Cycle | Target CPA | Target ROAS |
|---|---|---|
| Total Subscribers on Day 1 | 100 | 100 |
| After Same Day Disconnects | 91 | 93 |
| After Billing Cycle 1 | 49 | 54 |
| After Billing Cycle 2 | 44 | 47 |
| After Billing Cycle 3 | 43 | 47 |

It should be appreciated that such results indicate technical efficiencies of the model as disclosed herein. For example, unnecessary processing and delivery of advertisements to customers who would not stay long as a customer may be eliminated from the advertisement campaign.

### An Example Embodiment of the Integration of a High Value Customer Prediction Model for Valuing Future Auctions

Existing strategies implement flat bidding for all customers, applying uniform bid values for customer acquisition regardless of their revenue generation potential. An example is found in FIG. 2, bids 203, where each customer has a bid value of $10 regardless of their different revenue generation potential of $100, $300, and $500, respectively. The system disclosed herein addresses the challenge or problem of how to optimize profitability and enhance return on investment for each user. More specifically, some embodiments herein provide a value based bidding/high value customer prediction model through selective bid processing implemented in a call tracking platform.

In some embodiments, the value-based prediction model, also referred to as a type of tROAS model, places a premium on high-value customers to optimize profitability. One example consistent with embodiments herein has been demonstrated in the system architecture of FIG. 3.

Further, the value-based prediction model implements selective bid processing by computationally filtering low-value bid opportunities and prioritizing processing resources based on revenue metrics rather than transaction volume, thereby reducing server load, network bandwidth consumption, and processing overhead. This technical optimization directly reduces hardware and network resource as described above in the section, Efficiencies.

Further, consistent with embodiments herein, the value-based prediction model performs real-time data processing during automated live auctions for advertisement placement opportunities on advertisement bidding platforms (e.g., on Google's Smart Bidding platform), analyzing multiple-faceted parameters in multiple categories including credit metrics (including, e.g., credit score indicating creditworthiness of the prospective customer), geographical factors (e.g., whether the prospective customer is located in a rural area, suburban area, or urban area), service tier variables (e.g., basic programming packages, premium sports package, family entertainment package), and activation type (e.g., online self-activation, retail store activation, phone activation), and dynamically adjusting its bids accordingly. As another example, the multi-facet parameter framework can be adapted for product-based advertising, where the model analyzes: (1) credit metrics (e.g., credit score), (2) geographical factors (e.g., rural, suburban, or urban location), (3) product tier selection (e.g., for a consumer electronics vendor: premium vs. mid-range vs. entry-level devices; for a clothing retailer: luxury vs. contemporary vs. basic apparel; for a home goods store: professional-grade vs. standard vs. economy appliances), and (4) purchase channel type (e.g., online purchase, retail store purchase, phone order).

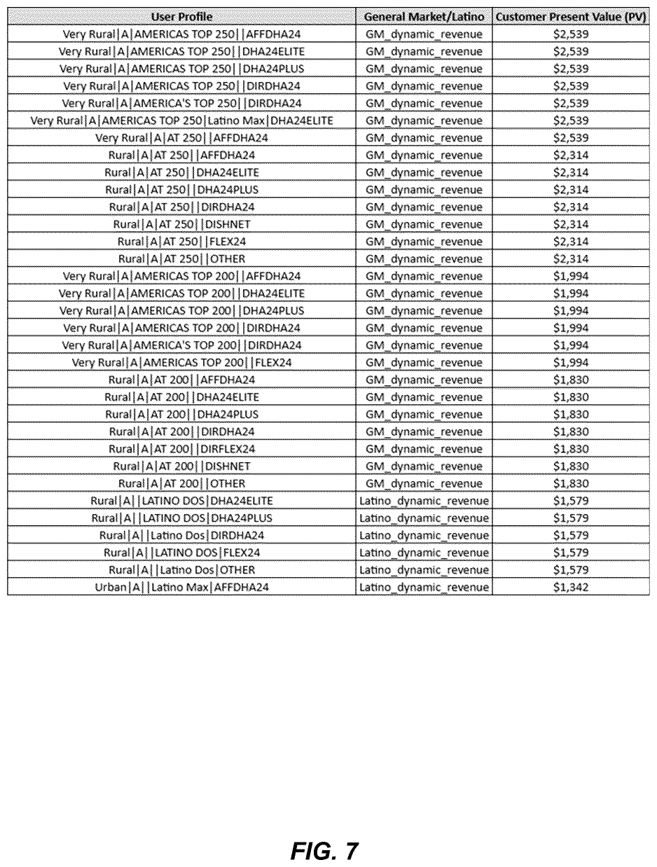

In some embodiments, a process includes providing present values (PVs), for example by a marketing finance team, to the system (e.g., to an interaction tracking platform 604 as illustrated in FIG. 6). The lookup table is compiled based on historical data of a population of users (or referred to as sample users) and used to determine the PV values of the sample users or other users during a live auction for advertisement placement opportunities on advertisement bidding platforms (e.g., on Google's Smart Bidding platform).

Merley by way of example, four types of factors are used to determine the PV of users during the auction. Such four types of factors are credit score, rurality, programming package, and activation type. For example, the factors that are input into PV calculation are as follows:
Credit Score
   <600, 600-619, 620-639, 640-659, 660-679, 680-699, >700
Rurality
   Very Rural, Rural, Suburban, Urban, Very Urban
Programming Package
   GM Flex Pack, GM AT 120, GM AT 120+, GM AT 200, GM AT 250
   Latino Clasico, Latino Plus, Latino Dos, Latino Max
Activation Type
   DHA Elite, Plus, Standard, Flex, Flex24

It should be appreciated that these specific data are provided by way of example only and are meant to be illustrative for understanding purposes. Other ranges of credit score, other categorizations of geographical areas, other categorizations of product packages, and other categorizations of product or services tiers are contemplated and within scope of the present disclosure.

FIG. 5 is an example lookup table used to determine present values of users, according to some embodiments. The present values (PVs) of users may be used to train the model 308 for guiding an auction for advertisement placement opportunities on an advertisement bidding platform (e.g., on Google's Smart Bidding platform). The table includes historical data of various sample users (e.g., prior or present customers), compiled by a vendor from transaction records and associated user information. The table is structured with multiple rows categorizing users by geographic or demographic characteristics (Very Rural, Rural, Suburban, Urban, Very Urban) and columns representing value ranges of credit scores of users from <540 to >=760, with intermediate ranges segmented in 20-point increments. Numbers in each cell of the table represents the estimated or assigned PV of customers in that demographic and credit score range intersection. The section delineated by the bold borders in the table represents high value users on whom the vendor would prioritize advertisement placement opportunities.

The lookup table, compiled based on historical data of various sample users, provides a quantitative framework for differentiating user profiles based on multi-variable revenue prediction metrics expressed as present values. The bold-bordered region in the table exemplifies high-value profiles, typically corresponding to users in Very Rural or Rural areas with present values exceeding 600. For instance, a customer located at a Very Rural area with a credit score in the range of 720-739 corresponds to a present value of 2,026, substantially higher than values outside this region. Conversely, profiles with lower revenue prediction metrics are represented by cells containing smaller numerical values, such as those corresponding to Very Urban areas or having present values below 600. This data-driven categorization enables the bidding system to implement precise bid calculations based on multiple variables including geographic location and present value parameters, thereby optimizing computational resources by focusing processing on user profiles with higher predicted revenue metrics.

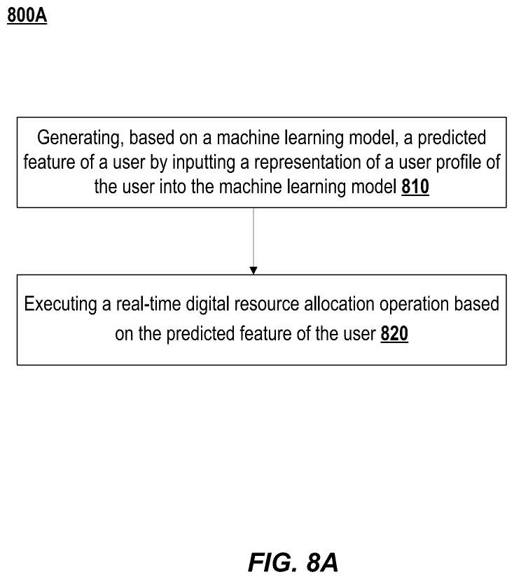

FIG. 6 is an architectural diagram for the value-based prediction system 600, according to some embodiments. The system 600 differs from system 300 (FIG. 3) in, e.g., its handling of customer interactions and demographic data. The multi-variable (or multi-faceted) lookup table (e.g., FIG. 5 or 7) is provided by a vendor (e.g., XYZvendor.com) to an interaction tracking platform 604 (e.g., Invoca). The interaction tracking platform 604 may be controlled by or in collaboration with the vendor. The interaction tracking platform 604 may serve functions including: passing the lookup table to the ad bidding platform 602 for use in advertisement targeting and dynamically generating unique toll-free numbers (TFNs) for tracking and attributing customer responses to specific advertising campaigns. The interaction tracking platform 604 is configured to track and/or correlate targeted advertisement placement data with subsequent user response data from a population of users, implementing attribution algorithms to map specific advertisement placement instances to resulting user actions. The interaction tracking platform 604 integrates user response data (spanning initiation, conversion, and termination events of multiple users) from digital interfaces, telecommunication systems (e.g., voice communication systems), and network-independent channels (e.g., physical location interfaces). This multi-channel data integration enables systematic analysis of user response effectiveness for specific advertisement targeting parameters across all response channels.

The ad bidding platform 602 (e.g., Google's Smart Bidding platform), uses the lookup table during real-time ad auctions to optimize bidding strategies. When an advertising opportunity arises, platform 602 analyzes the prospective customer's profile and compares it against the profiles of high-PV users in the lookup table. For prospects whose profiles closely match those of high-PV users, the platform increases bid amounts to improve the chances of winning the ad auction. The analysis of the profile of a prospect with respect to the multi-variable lookup table may be performed using a machine learning model. Once the ad is won, the advertisement or landing page displayed to the prospect includes a dynamic TFN generated by platform 604. When prospects call these TFNs, they connect with the vendor's communication processing center 606, which collects call disposition data (including user profile information such as geographic location and credit score) and order data (including programming package type and activation type). This collected information is stored in data center 608.

In some embodiments, a value-based prediction model segments prospects based on four (4) different variables including credit score, rurality (geographical categorization), programming package, and activation data. Unlike system 300 which uses an ML model (model 308) for analyzing prospect for an ad bidding, system 600 uses a lookup table approach. The lookup table provides present values (PVs) for different combinations of the variables of interest, calculated based on historical customer data. For example, the lookup table may indicate higher PVs for customers with certain combinations of credit scores and geographical locations who selected particular programming packages and activation types. When new customers are acquired through the targeted advertisements, their order value and profile data are sent to data center 608. The data center 608 uses this new performance data to periodically update the lookup table values (e.g., quarterly or semi-annually). The interaction tracking platform 604 then provides the updated lookup table to the ad bidding platform 602 for use in subsequent ad auctions, as indicated by “(Passback order data to online Advertisement Bidding Platform)” from 604 to 602. This creates a continuous improvement loop where real campaign performance data helps refine the identification and targeting of high-value prospects. This approach differs from the system 300 as it leverages demographic data obtained through, e.g., credit checks, enabling more precise targeting of potential high-value customers.

For lookup table implementations, the system 600 may employ a data-driven approach to select which parameters to include in the table. The selection process may include analyzing historical customer data to identify parameters that have strong correlations with customer value and retention. For example, analysis of historical data might reveal that certain combinations of parameters—such as credit score ranges (e.g., above 750, 650-750, below 650), geographical locations (e.g., urban, suburban, rural), and service package selections (e.g., basic, premium, luxury)—are particularly predictive of customer lifetime value.

The parameter selection process may be guided by multiple considerations and evaluation metrics. The system 600 may calculate correlation coefficients between each parameter and customer value metrics, such as retention duration and revenue generation. For example, if credit score shows a correlation coefficient above 0.7 with customer lifetime value, it may be identified as a strong predictor. The system 600 may also consider joint predictive power of parameter combinations using techniques such as mutual information analysis and feature importance rankings. Each parameter is evaluated for data availability—for instance, while income level may be highly predictive, it may not be readily available during real-time bidding, making it less suitable for inclusion. The system 600 may also monitor computational costs, measuring lookup time impact as new parameters are added and setting thresholds for acceptable performance degradation.

The system 600 may implement a dynamic parameter refinement process through a sophisticated technical framework. For example, the system 600 maintains a shadow table structure where new potential parameters are tested before being incorporated into the production lookup table. The system 600 runs periodic batch processes to calculate updated predictive power metrics for all parameters, using sliding time windows to capture recent trends. For example, if viewership patterns emerge as increasingly predictive of customer value, the system 600 may begin tracking and incorporating specific viewing behavior parameters. The update process uses atomic operations to modify the lookup table structure without disrupting ongoing bidding operations. When parameters are added or removed, the system 600 automatically recomputes value predictions for affected combinations and updates the table indices to maintain optimal lookup performance. Version control mechanisms ensure that the system 600 can rollback changes if newly added parameters don't perform as expected in production. The lookup table creation and update may be performed by the data center 608.

Additionally or alternatively, the machine learning model used by the bidding platform 602 to perform online analysis of profiles of prospects with respect to the lookup table may be iteratively trained. For example, a first training set is created for training the model. The data center 608 creates the initial, first training set by compiling user demographic information, and historical customer data, including, e.g., credit score, a categorization of geographical areas, a categorization of product or service packages or tiers, and activation data. Examples of user demographic information include age, gender, income level, education level, occupation, ethnicity, family status, language, interests or hobbies, etc. The model is trained in a first stage using the first training set. It is the first stage data that are used as input to the bidding platform 602 for online use, which outputs the high-value audience (or prospect) segment and de-prioritizes low value audience (or prospect) segment for targeted advertisement placements. Once new customers are acquired, their order value (value they have brought in) may be collected by the data center 608. The data center 608 creates a second (or subsequent) training set for a second (or subsequent) stage of training. The second training set includes but is not limited to the first training set and updated user demographic information, known user purchase history subsequent (e.g., in response to) the targeted advertisements, and variables: credit score, a categorization of geographical areas, a categorization of product or service packages or tiers, and activation data that indicate corrections to the first training set. Then the machine learning model is trained in a second (or subsequent) stage using the second (or subsequent) training set.

FIG. 7 is an example lookup table used to determine PV values of users during an auction for advertisement placement opportunities, according to some embodiments.
First Column: Represents user profile based on four different factors by which user value (PV) is determined, including Rurality, Credit Score, Package Type, and Activation Type, respectively.

### Rural| A| AT 200| DHA24ELITE

For example, the row illustrated above represents a rural user with a class A credit score opting in for AT 200 package and DHA24Elite activation type has a present value of $1,830 to the business. The credit scores of users may be represented in the form of groupings (e.g., class A, class B, etc.) as illustrated in FIG. 7, absolute values, normalized values, etc.
Second Column: Lookup table name “GM_dynamic_revenue.”
Third Column: Customer Present Values (PV) with respect to their profiles in the first column.

### Exemplary Flows

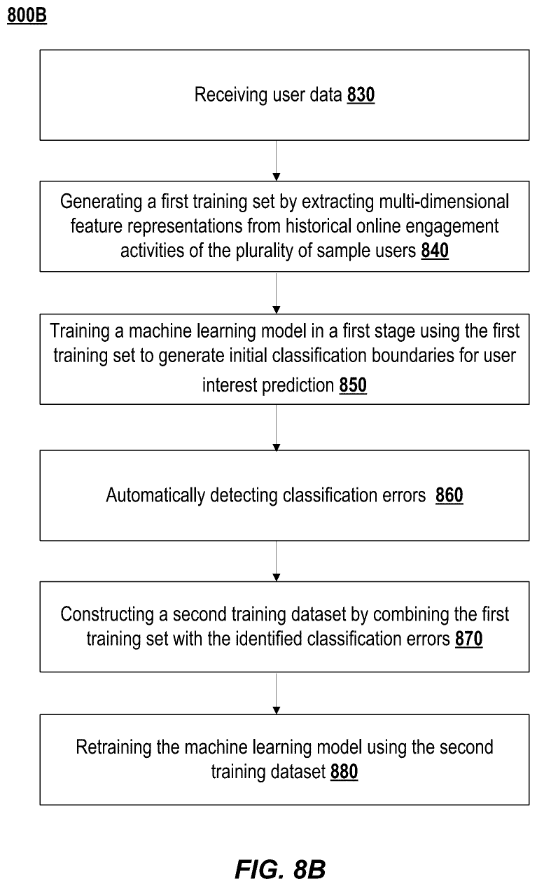

FIG. 8A illustrates a flowchart of a process 800A for allocating digital resource, according to some embodiments of the present technology. In block 810, a system (e.g., system 300, system 600) generates a predicted feature of a user by inputting a representation of a user profile of the user into a machine learning model. For example, this operation may correspond to the functions performed by the ad bidding model 308 and bid adjustments processor 310 in FIG. 3. The model processes user profile information to generate predictions for optimized targeting.

Merley by way of example, the user is a prospective user of a vendor. The user profile may become available for this assessment when the user is viewing content on a webpage, using a search engine, or using an application, creating an opportunity for displaying an advertisement of the vendor to the user. For instance, when an advertisement slot becomes available on a webpage the user is viewing, in search results the user has requested, or in an application the user is using, the system receives information about this available advertisement slot along with information about the user, triggering the process of predicting the user's potential value for the vendor to determine appropriate bidding strategy for the advertisement opportunity.

The user profile may include multi-faceted information regarding the user with respect to an engagement of interest. For example, as described in connection with the vendor database 302 of FIG. 3, such information may include customer identifiers (IDs), transaction histories showing previously purchased products or services, engagement duration metrics indicating customer tenure, advertisement interaction data showing websites visited that served advertisements, viewership data including accounts watched and duration of watching, and customer segment data. The user profile information may be preprocessed into appropriate representations before being input to the machine learning model. For example, as described in connection with components 304 and 306 of FIG. 3, the preprocessing may involve data manipulation and standardization, converting the multi-faceted information into formats suitable for machine learning analysis, such as numerical representations or normalized values.

The machine learning model may be trained using a gradient boosting technique. Examples of the base model of the machine learning model includes a decision tree, random forest, gradient-boosted decision tree, support vector machine (SVM), logistic regression model, k-nearest neighbors (k-NN) model, naive Bayes classifier, or the like, or a combination thereof.

In some embodiments, the machine learning model is configured to receive numerical input for efficient processing and analysis. The representation provided to the model may include a multi-dimensional feature vector that has been pre-processed to optimize model performance. The pre-processing includes vectorization of categorical features, which converts non-numerical categories into numerical representations using techniques such as one-hot encoding, label encoding, or learned embeddings. The pre-processing also includes scaling numerical features to a normalized range (e.g., between 0 and 1, or −1 and 1) to allow consistent treatment of features with different natural scales. This normalization helps prevent features with larger absolute values from dominating the model's predictions.

The machine learning model may output various types of predictions based on the input user profile. For example, as described in connection with model 308 in FIG. 3, the model may function as a classifier that categorizes potential customer profiles based on their predicted value to a vendor. In an exemplary implementation, the model may classify prospects into two classes: a first class including profiles of preferred customers predicted to generate higher value for the vendor (e.g., profiles sharing characteristics with high-value customers) and a second class including profiles of customers predicted to generate lower value, who may be excluded from resource allocation (e.g., profiles similar to low-value customers). In another exemplary implementations, the model may classify prospects into multiple value-based classes such as very high value, high value, moderate value, low value, and very low value. Alternatively, the classification may be based on predicted value ranges (e.g., above $300, between $200 and $300, between $100 and $200, or below $100). These classifications and value predictions enable the implementation of more nuanced strategies in the subsequent resource allocation operations. For example, as described in FIG. 3, the model's outputs may be used by processor 310 to implement different bidding strategies, such as bidding aggressively for very high value prospects, moderately for high value prospects, conservatively for moderate value prospects, and potentially excluding low or very low value prospects from the campaign.

In alternative embodiments, the machine learning model is implemented as a tree-based model configured to support non-vectorized inputs, allowing direct processing of raw or minimally processed data formats. Examples of non-vectorized inputs include categorical data in their original form (e.g., “urban”, “suburban”, “rural” for location categories; “basic,” “premium,” “luxury” for service or product tiers), text strings (e.g., product descriptions, customer feedback), timestamps in various formats, or mixed data types combining numerical and non-numerical values. Tree-based models can naturally handle such heterogeneous data through their splitting mechanisms, making decisions based on categorical equality or numerical thresholds without requiring explicit conversion to vector format.

In some embodiments, the predicted feature may be determined based on a model other than the machine learning model. For example, as described in connection with system 600 of FIG. 6, the system may determine the predicted feature based on a lookup table approach instead of machine learning classification. The lookup table may store present values (PVs) calculated from historical customer data for different combinations of multiple variables. For example, in one implementation, the lookup table may combine four variables: credit score, rurality (geographical categorization), programming package, and activation type. FIGS. 5 and 7 provide examples of lookup tables applicable here. When predicting a feature for a prospective user, the system analyzes the user's profile against the profiles of high-PV users stored in the lookup table. The lookup table approach may be advantageous when the system has access to detailed demographic data, such as credit check information. The lookup table may be periodically updated (e.g., quarterly or semi-annually) based on actual performance data from newly acquired customers, creating a feedback loop for continuous improvement of value predictions. This approach enables systematic analysis of user value across different variable combinations and allows for regular refinement of prediction accuracy based on real-world performance data.

The predicted feature output by the model may represent, for example, the customer's projected lifetime value to the vendor, expected revenue generation, predicted retention period, or anticipated engagement level. The output of the model may be used by processor 310 to implement a bidding strategy in a real-time auction. In some embodiments, the system may determine a bid amount based on the predicted feature as part of the operation 810 or 820.

In block 820, the system executes a real-time digital resource allocation operation based on the predicted feature of the user. Merley by way of example, the digital resource allocation involves participating in a real-time auction for an advertisement spot that has become available on a digital platform where the user is present—for example, an advertisement slot on a webpage the user is viewing, a sponsored position in search results the user has requested, or an advertisement space in an application the user is using. The system determines how much to bid in the real-time auction based on the predicted feature of the user, with the bid amount representing the maximum price the system is willing to pay for winning that advertisement impression. The auction outcome determines whether the system wins the right to display the vendor's advertisement to the user in the available spot, with higher bid amounts increasing the likelihood of winning the auction and having the advertisement displayed to that user.

As described in connection with FIG. 3, the system may implement different bidding strategies based on the predicted features—for example, bidding aggressively for prospects predicted to have very high value, moderately for those with high value, conservatively for those with moderate value, and potentially excluding those predicted to have low value from the campaign.

Alternatively, as described in connection with FIG. 6, when an advertising opportunity arises, the system (e.g., online advertisement bidding platform 602) may analyze the prospective user's profile against profiles of high-PV (present value) users in a lookup table and adjust bid amounts accordingly. After winning an auction, the advertisement or landing page displayed to the prospect may include a dynamically generated toll-free number (TFN) for tracking response to the advertisement. The system may then track and analyze user responses across multiple channels, including digital interfaces (e.g., click-throughs, webpage interactions), telecommunication systems (e.g., calls to the TFNs), and other response channels. This multi-channel tracking enables systematic analysis of the effectiveness of the resource allocation decisions.

In both implementations, the system may collect performance data from the resource allocation operations to enable continuous improvement. For example, the system may track customer engagement metrics such as ad click-throughs, conversion rates, and post-conversion behaviors. This performance data may be used to update the machine learning model's training data or the lookup table values, creating a feedback loop that helps refine future resource allocation decisions.

FIG. 8B illustrates a flowchart of a process 800B for generating a machine learning model used in digital resource allocation, according to some embodiments. In block 830, a processor receives user data of sample users from a data source (e.g., vendor database 302 storing historical customer data). The process may include one or more processors on, coupled to, or otherwise configured to provide the trained model to the processor 310. As described in connection with in FIG. 3, such data may include customer identifiers (IDs), transaction histories showing previously purchased products or services, engagement duration metrics indicating customer tenure, advertisement interaction data (including websites visited that served vendor's advertisements), viewership data (including vendor accounts watched and duration of watching such accounts, genres of broadcasting data), and customer segment data (e.g., NBA cohort, News cohort for vendors like Sling or DISH). In some embodiments, the sample users include only desirable customers based on their value to the vendor. In some embodiments, the sample users include both desirable and undesirable customers based on their value to the vendor. For example, the sample users may include customers who have demonstrated high value through longer retention periods and higher revenue generation (desirable customers) and those who have demonstrated lower value or early churn (undesirable customers). The model is trained to analyze a prospective user's profile and predict whether the prospect is likely to become a desirable customer for the vendor, enabling more efficient allocation of advertising resources.

In block 840, the processor generates a first training set by extracting multi-dimensional feature representations from historical online engagement activities of the plurality of sample users. This operation may correspond to the data manipulation and standardization functionality performed by the tROAS model 304 and analysis by the CLV calculations processor 306 in FIG. 3. The feature representations may include multi-dimensional feature vectors that have been pre-processed through techniques such as vectorization of categorical features and scaling of numerical features to a normalized range. The vectorization of categorical features may be performed using one or more techniques of one-hot encoding, label encoding, or learned embeddings.

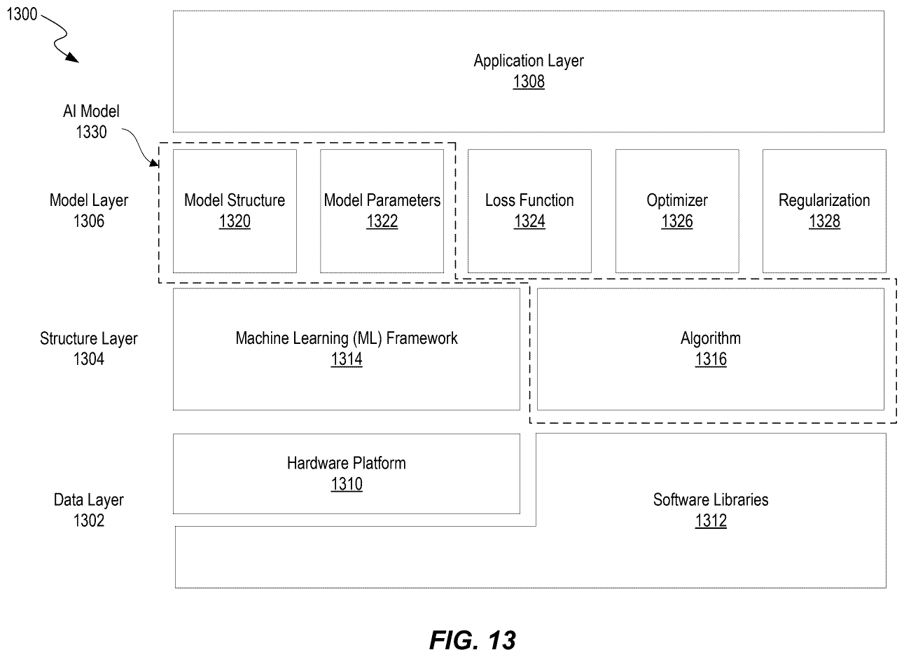

In block 850, the system trains a machine learning model (e.g., ad bidding model 308 in FIG. 3; AI model 1330, model structure 1320, model parameters 1322, and algorithm 1316 in FIG. 13) in a first stage using the first training set to generate initial classification boundaries for user interest prediction. The machine learning model may be implemented as a tree-based model configured to support non-vectorized inputs, or may include one or more base models such as a decision tree, random forest, gradient-boosted decision tree, support vector machine (SVM), logistic regression model, k-nearest neighbors (k-NN) model, or naive Bayes classifier. The model may be trained using gradient boosting techniques.

In block 860, the system automatically detects classification errors in the initial machine learning model's predictions. As described in connection with components 308 and 310 in FIG. 3, this error detection process involves analyzing the model's performance on the first training set to identify misclassified cases. Specifically, the system identifies one or both of the two types of classification errors:

First, the system identifies a first subset of users who were incorrectly classified as interested (i.e., false positives). These are users who the initial model predicted would be high-value customers but, based on their actual digital engagement metrics (such as activation in response or subsequent to an advertisement, retention periods, revenue generation patterns, engagement levels, etc.), turned out to be low-value customers. For example, this may include customers who did not purchase the service or product in the advertisement, churned quickly or generated lower revenue than predicted.

Second, the system identifies a second subset of users who were incorrectly classified as uninterested (i.e., false negatives). These are users who the initial model predicted would be low-value customers but, based on their actual digital engagement metrics, proved to be high-value customers. For example, this may include customers who maintained longer subscriptions or generated higher revenue than predicted.

The identification of these classification errors involves computing confidence scores for the model's classifications, comparing predicted customer value levels against actual observed values, and analyzing patterns in misclassified cases to understand common characteristics that led to incorrect predictions. These identified errors significantly influence the subsequent training process. As described in blocks 870 and 880, the system uses these misclassified cases to construct a second training dataset that specifically addresses these prediction weaknesses. The second training stage then focuses on improving the model's ability to correctly classify cases similar to those that were initially misclassified, leading to more accurate predictions of customer value. This iterative refinement process helps the model develop more nuanced classification boundaries that better reflect actual customer behavior patterns.

In block 870, the system constructs a second training dataset based on (e.g., by combining) the first training set with the identified classification errors. This operation may utilize feedback data collected by the better quality customers processor 312 and stored in vendor database 302 of FIG. 3. Then, in block 880, the system retrains the machine learning model using this second training dataset. This two-stage training process helps refine the model's ability to accurately classify users and predict their potential value to a vendor.

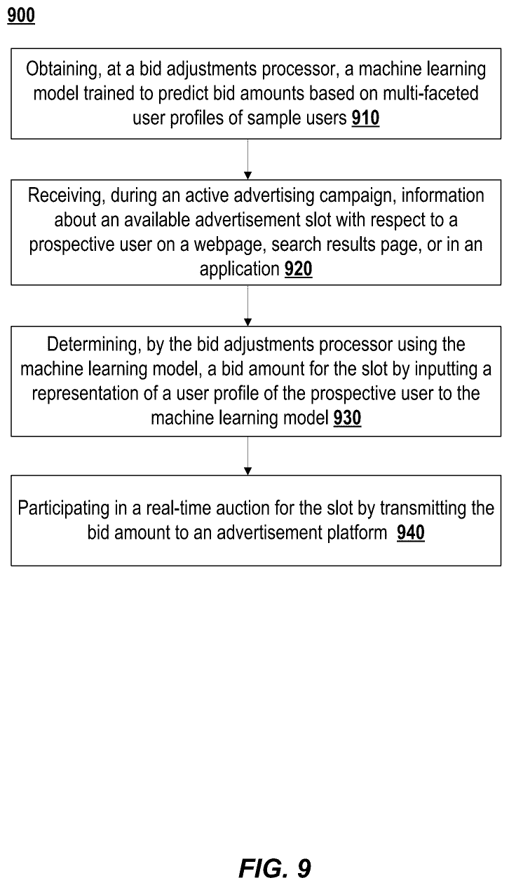

The resulting trained model may be used by the bid adjustments processor 310 of FIG. 3 in the operations described in FIGS. 8A and 9, where it processes user profiles to generate predictions for optimized targeting in real-time digital resource allocation operations such as advertisement placement auctions.

FIG. 9 illustrates a flowchart of a process 900 for performing real-time advertisement bidding, according to some embodiments of the present technology. In block 910, a bid adjustments processor (e.g., processor 310, online advertisement bidding platform 602) obtains a prediction model for determining bid amounts with respect to prospective users. This model may be a machine learning model trained in a single- or multi-stage training through the process described in FIG. 8B. As described in FIG. 8B, a multi-stage training, or an iteratively updated model, may be performed to improve classification accuracy by incorporating identified error cases. Alternatively, as described in connection with FIGS. 5, 6, and 7, the system may use a lookup table approach that stores present values (PVs) for different combinations of user attributes such as credit score, geographical location, programming package preferences, and activation type.

In block 920, during an active advertising campaign, the system receives information about an available advertisement slot. This opportunity arises when a prospective user is actively viewing content on a webpage, reviewing search results, or using an application where an advertisement can be displayed. Along with the slot availability information, the system receives information about the prospective user who may view the advertisement if the auction is won.

In block 930, the bid adjustments processor determines an appropriate bid amount for the available advertisement slot in one of two ways. In a first approach using the trained machine learning model, the processor inputs a representation of the prospective user's profile into the model, which analyzes the user's characteristics to predict their potential value. In a second approach using the lookup table, the processor compares the prospective user's profile against profiles of known high-PV users in the table. In either approach, the predicted value is used to determine an appropriate bid amount, with higher bids for users predicted to have higher value to the vendor.

In block 940, the system participates in a real-time auction for the advertisement slot by transmitting the determined bid amount to an advertisement platform (e.g., Google's Smart Bidding platform). The bid amount represents the maximum price the system is willing to pay for the opportunity to display an advertisement to this specific user in this specific slot. If the bid wins the auction, the system's advertisement will be displayed to the user in the available slot.

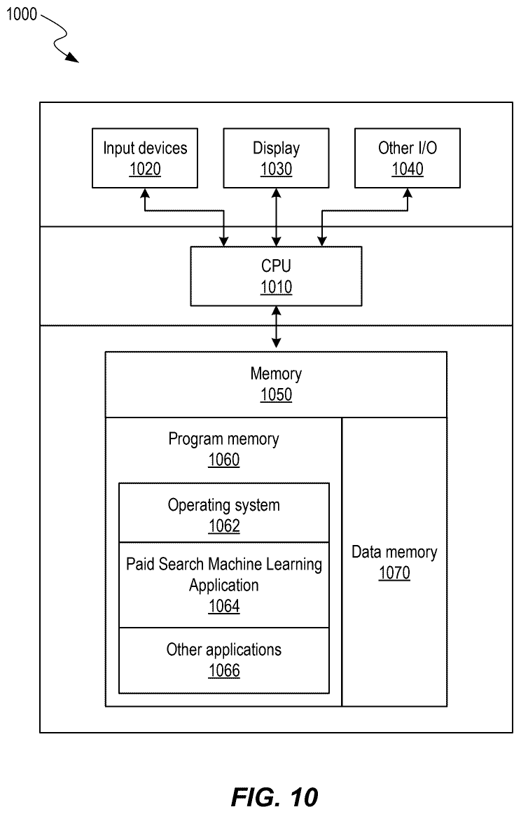

Several implementations are discussed below in more detail in reference to the figures. FIG. 10 is a block diagram illustrating an overview of devices on which some implementations of the disclosed technology can operate. The devices can comprise hardware components of a device 1000. Device 1000 can include one or more input devices 1020 that provide input to the CPU (processor) 1010, notifying it of actions. The actions are typically mediated by a hardware controller that interprets the signals received from the input device and communicates the information to the CPU 1010 using a communication protocol. Input devices 1020 include, for example, a mouse, a keyboard, a touchscreen, an infrared sensor, a touchpad, a wearable input device, a camera- or image-based input device, a microphone, or other user input devices.

CPU 1010 can be a single processing unit or multiple processing units in a device or distributed across multiple devices. CPU 1010 can be coupled to other hardware devices, for example, with the use of a bus, such as a PCI bus or SCSI bus. The CPU 1010 can communicate with a hardware controller for devices, such as for a display 1030. Display 1030 can be used to display text and graphics. In some examples, display 1030 provides graphical and textual visual feedback to a user. In some implementations, display 1030 includes the input device as part of the display, such as when the input device is a touchscreen or is equipped with an eye direction monitoring system. In some implementations, the display is separate from the input device. Examples of display devices include: televisions; mobile devices; an LCD display screen; an LED display screen; a projected, holographic, or augmented reality display (such as a heads-up display device or a head-mounted device); and so on. Other I/O devices 1040 can also be coupled to the processor, such as a network card, video card, audio card, USB, FireWire or other external device, camera, printer, speakers, CD-ROM drive, DVD drive, disk drive, or Blu-Ray device.

In some implementations, the device 1000 also includes a communication device capable of communicating wirelessly or wire-based with a network node. The communication device can communicate with another device or a server through a network using, for example, TCP/IP protocols. Device 1000 can utilize the communication device to distribute operations across multiple network devices.

The CPU 1010 can have access to a memory 1050. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 1050 can include program memory 1060 that stores programs and software, such as an operating system 1062, a viewing environment adjustment application 1064, and other application programs 1066. Memory 1050 can also include data memory 1070 that can include speaker information, etc., which can be provided to the program memory 1060 or any element of the device 1000.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, mobile phones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

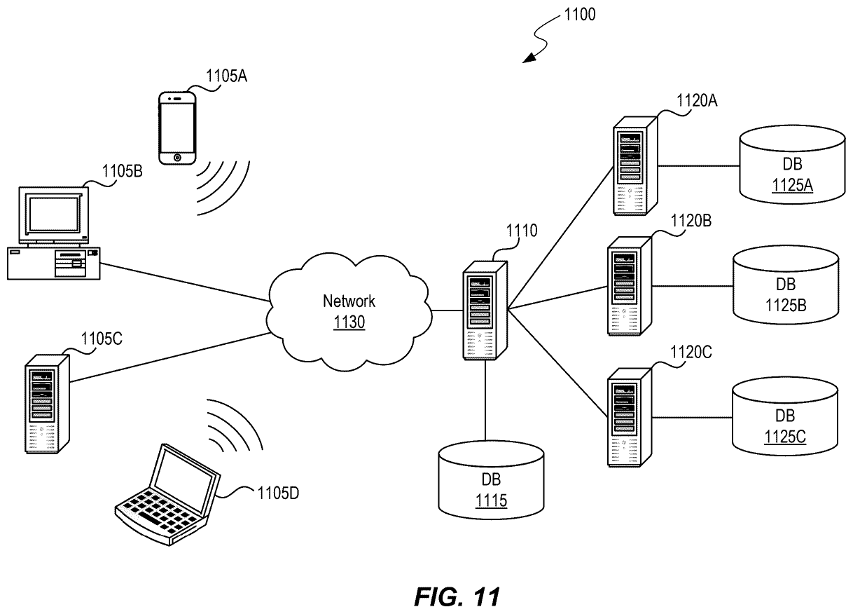

FIG. 11 is a block diagram illustrating an overview of an environment 1100 in which some implementations of the disclosed technology can operate. Environment 1100 can include one or more client computing devices 1105A-D, examples of which can include device 400. Client computing devices 1105 can operate in a networked environment using logical connections through network 1130 to one or more remote computers, such as a server computing device 1110.

In some implementations, server computing device 1110 can be an edge server that receives client requests and coordinates fulfillment of those requests through other servers, such as servers 1120A-C. Server computing devices 1110 and 1120 can comprise computing systems, such as device 400. Though each server computing device 1110 and 1120 is displayed logically as a single server, server computing devices can each be a distributed computing environment encompassing multiple computing devices located at the same or at geographically disparate physical locations. In some implementations, each server computing device 1120 corresponds to a group of servers.

Client computing devices 1105 and server computing devices 1110 and 1120 can each act as a server or client to other server/client devices. Server 1110 can connect to a database 1115. Servers 1120A-C can each connect to a corresponding database 1125A-C. As discussed above, each server 1120 can correspond to a group of servers, and each of these servers can share a database or can have their own database. Databases 1115 and 1125 can warehouse (e.g., store) information such as speaker information, speaker characteristics (e.g., frequency range and/or timing delay), channel selections, and/or user preferences. Though databases 1115 and 1125 are displayed logically as single units, databases 1115 and 1125 can each be a distributed computing environment encompassing multiple computing devices, can be located within their corresponding server, or can be located at the same or at geographically disparate physical locations.

Network 1130 can be a local area network (LAN) or a wide area network (WAN), but can also be other wired or wireless networks. Network 1130 may be the Internet or some other public or private network. Client computing devices 1105 can be connected to network 1130 through a network interface, such as by wired or wireless communication. While the connections between server 1110 and servers 1120 are shown as separate connections, these connections can be any kind of local, wide area, wired, or wireless network, including network 1130 or a separate public or private network.

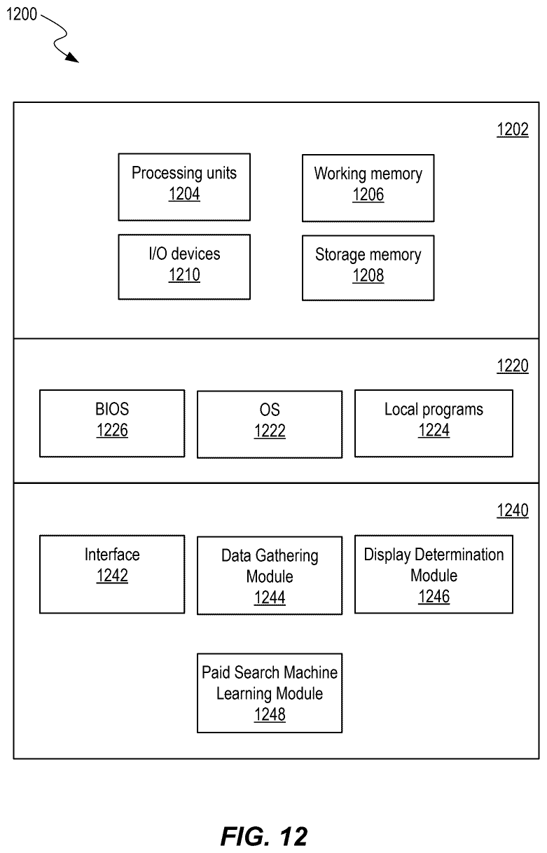

FIG. 12 is a block diagram illustrating components 1200 which, in some implementations, can be used in a system employing the disclosed technology. The components 1200 include hardware 1202, general software 1220, and specialized components 1240. As discussed above, a system implementing the disclosed technology can use various hardware, including processing units 1204 (e.g., CPUs, GPUs, APUs, etc.), working memory 1206, storage memory 1208, and input and output devices 1210. Components 1200 can be implemented in a client computing device such as client computing devices 1105 or on a server computing device, such as server computing device 1110 or 1120.

General software 1220 can include various applications, including an operating system 1222, local programs 1224, and a basic input output system (BIOS) 1226. Specialized components 1240 can be subcomponents of a general software application 1220, such as local programs 1224. Specialized components 1240 can include a Data Gathering module 1244, Display Determination module 1246, Environment Adjustment module 1248, and components that can be used for transferring data and controlling the specialized components, such as interface 1242. In some implementations, components 1200 can be in a computing system that is distributed across multiple computing devices or can be an interface to a server-based application executing one or more of specialized components 1240.

Those skilled in the art will appreciate that the components illustrated in FIGS. 10-12 described above, and in each of the flow diagrams discussed above, may be altered in a variety of ways. For example, the order of the logic may be rearranged, sub steps may be performed in parallel, illustrated logic may be omitted, other logic may be included, etc. In some implementations, one or more of the components described above can execute one or more of the processes described below.

### An Exemplary AI Architecture

Some embodiments of the AI engine can be understood with reference to FIG. 13. FIG. 13 is an AI architecture, according to some embodiments. As shown, the AI system 1300 can include a set of layers, which conceptually organize elements within an example network topology for the AI system's architecture to implement a particular AI model 1330. Generally, an AI model 1330 is a computer-executable program implemented by the AI system 1300 that analyses data to make predictions. Information can pass through each layer of the AI system 1300 to generate outputs for the AI model 1330. The layers can include a data layer 1302, a structure layer 1304, a model layer 1306, and an application layer 1308. The algorithm 1316 of the structure layer 1304 and the model structure 1320 and model parameters 1322 of the model layer 1306 together form the example AI model 1330. The optimizer 1326, loss function engine 1324, and regularization engine 1328 work to refine and optimize the AI model 1330, and the data layer 1302 provides resources and support for application of the AI model 1330 by the application layer 1308.

The data layer 1302 acts as the foundation of the AI system 1300 by preparing data for the AI model 1330. As shown, the data layer 1302 can include two sub-layers: a hardware platform 1310 and one or more software libraries 1312. The hardware platform 1310 can be designed to perform operations for the AI model 1330 and include computing resources for storage, memory, logic and networking, such as the resources described in relation to FIG. 3 and FIG. 6. The hardware platform 1310 can process amounts of data using one or more servers. The servers can perform backend operations such as matrix calculations, parallel calculations, machine learning (ML) training, and the like. Examples of servers used by the hardware platform 1310 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1310 can include Infrastructure as a Service (IaaS) resources, which are computing resources, (e.g., servers, memory, etc.) offered by a cloud services provider. The hardware platform 1310 can also include computer memory for storing data about the AI model 1330, application of the AI model 1330, and training data for the AI model 1330. The computer memory can be a form of random-access memory (RAM), such as dynamic RAM, static RAM, and non-volatile RAM.

The software libraries 1312 can be thought of as suites of data and programming code, including executables, used to control the computing resources of the hardware platform 1310. The programming code can include low-level primitives (e.g., fundamental language elements) that form the foundation of one or more low-level programming languages, such that servers of the hardware platform 1310 can use the low-level primitives to carry out specific operations. The low-level programming languages do not require much, if any, abstraction from a computing resource's instruction set architecture, allowing them to run quickly with a small memory footprint. Examples of software libraries 1312 that can be included in the AI system 1300 include Intel Math Kernel Library, Nvidia cuDNN, Eigen, and Open BLAS.

The structure layer 1304 can include an ML framework 1314 and an algorithm 1316. The ML framework 1314 can be thought of as an interface, library, or tool that allows users to build and deploy the AI model 1330. The ML framework 1314 can include an open-source library, an application programming interface (API), a gradient-boosting library, an ensemble method, and/or a deep learning toolkit that work with the layers of the AI system facilitate development of the AI model 1330. For example, the ML framework 1314 can distribute processes for application or training of the AI model 1330 across multiple resources in the hardware platform 1310. The ML framework 1314 can also include a set of pre-built components that have the functionality to implement and train the AI model 1330 and allow users to use pre-built functions and classes to construct and train the AI model 1330. Thus, the ML framework 1314 can be used to facilitate data engineering, development, hyperparameter tuning, testing, and training for the AI model 1330. Examples of ML frameworks 1314 that can be used in the AI system 1300 include TensorFlow, PyTorch, Scikit-Learn, Keras, Cafffe, LightGBM, Random Forest, and Amazon Web Services.

The algorithm 1316 can be an organized set of computer-executable operations used to generate output data from a set of input data and can be described using pseudocode. The algorithm 1316 can include complex code that allows the computing resources to learn from new input data and create new/modified outputs based on what was learned. In some implementations, the algorithm 1316 can build the AI model 1330 through being trained while running computing resources of the hardware platform 1310. This training allows the algorithm 1316 to make predictions or decisions without being explicitly programmed to do so. Once trained, the algorithm 1316 can run at the computing resources as part of the AI model 1330 to make predictions or decisions, improve computing resource performance, or perform tasks. The algorithm 1316 can be trained using supervised learning, unsupervised learning, semi-supervised learning, and/or reinforcement learning.

Using supervised learning, the algorithm 1316 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include but are not limited to initial viewership behavior, initial online behavior, the initial package they came in with, the initially assigned probabilities for the viewers, a list of customers, products or services purchased by customers on the list of customers, statuses of the customers, broadcast viewership data of the customers, online engagement activities of the customers, customers initial point of entry data, a first subset of customers in the list of customers that are incorrectly detected as customers after the first training set and a second subset of customers in the list of customer that are incorrectly detected as having a lower customer value than an associated corrected higher customer value with regard to FIG. 3. With regard to FIG. 6, training data can include but are not limited to user demographic information, known user purchase history, and four variables: credit score, a categorization of geographical areas, a categorization of product or service packages, and a categorization of product or service tiers. The user may label the training data based on one or more classes and trains the AI model 1330 by inputting the training data to the algorithm 1316. The algorithm determines how to label the new data based on the labeled training data. The user can facilitate collection, labeling, and/or input via the ML framework 1314. In some instances, the user may convert the training data to a set of feature vectors for input to the algorithm 1316. Once trained, the user can test the algorithm 1316 on new data to determine if the algorithm 1316 is predicting accurate labels for the new data. For example, the user can use cross-validation methods to test the accuracy of the algorithm 1316 and retrain the algorithm 1316 on new training data if the results of the cross-validation are below an accuracy threshold.

Supervised learning can involve classification and/or regression. Classification techniques involve teaching the algorithm 1316 to identify a category of new observations based on training data and are used when input data for the algorithm 1316 is discrete. Said differently, when learning through classification techniques, the algorithm 1316 receives training data labeled with categories (e.g., classes) and determines how features observed in the training data (e.g., products or services purchased by customers on the list of customers) relate to the categories (e.g., products or services categories). Once trained, the algorithm 1316 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 1316 is continuous. Regression techniques can be used to train the algorithm 1316 to predict or forecast relationships between variables. To train the algorithm 1316 using regression techniques, a user can select a regression method for estimating the parameters of the model. The user collects and labels training data that is input to the algorithm 1316 such that the algorithm 1316 is trained to understand the relationship between data features and the dependent variable(s). Once trained, the algorithm 1316 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 1316 learns patterns from unlabeled training data. In particular, the algorithm 1316 is trained to learn hidden patterns and insights of input data, which can be used for data exploration or for generating new data. Here, the algorithm 1316 does not have a predefined output, unlike the labels output when the algorithm 1316 is trained using supervised learning. Said another way, unsupervised learning is used to train the algorithm 1316 to find an underlying structure of a set of data, group the data according to similarities, and represent that set of data in a compressed format. The platform for computing the CLV of each customer can use unsupervised learning to identify patterns (e.g., to identify particular online customer engagement or purchases) and so forth. In some implementations, performance of the tROAS model 304 that can use unsupervised learning is improved because it can identify customers who are candidates for a greater than expected CLV, as described herein.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 1316 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 1316 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 1316 include factor analysis, item response theory, latent profile analysis, and latent class analysis.

The model layer 1306 implements the AI model 1330 using data from the data layer and the algorithm 1316 and ML framework 1314 from the structure layer 1304, thus enabling decision-making capabilities of the AI system 1300. The model layer 1306 includes a model structure 1320, model parameters 1322, a loss function engine 1324, an optimizer 1326, and a regularization engine 1328.

The model structure 1320 describes the architecture of the AI model 1330 of the AI system 1300. The model structure 1320 defines the complexity of the pattern/relationship that the AI model 1330 expresses. Examples of structures that can be used as the model structure 1320 include decision trees, support vector machines, regression analyses, Bayesian networks, Gaussian processes, genetic algorithms, and artificial neural networks (or, simply, neural networks). The model structure 1320 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 1320 may include one or more hidden layers of nodes between the input and output layers. The model structure 1320 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 1322 represent the relationships learned during training and can be used to make predictions and decisions based on input data. The model parameters 1322 can weight and bias the nodes and connections of the model structure 1320. For instance, when the model structure 1320 is a neural network, the model parameters 1322 can weight and bias the nodes in each layer of the neural networks, such that the weights determine the strength of the nodes and the biases determine the thresholds for the activation functions of each node. The model parameters 1322, in conjunction with the activation functions of the nodes, determine how input data is transformed into desired outputs. The model parameters 1322 can be determined and/or altered during training of the algorithm 1316.

The loss function engine 1324 can determine a loss function, which is a metric used to evaluate the AI model's 1330 performance during training. For instance, the loss function engine 1324 can measure the difference between a predicted output of the AI model 1330 and the actual output of the AI model 1330 and is used to guide optimization of the AI model 1330 during training to minimize the loss function. The loss function may be presented via the ML framework 1314, such that a user can determine whether to retrain or otherwise alter the algorithm 1316 if the loss function is over a threshold. In some instances, the algorithm 1316 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 1326 adjusts the model parameters 1322 to minimize the loss function during training of the algorithm 1316. In other words, the optimizer 1326 uses the loss function generated by the loss function engine 1324 as a guide to determine what model parameters lead to the most accurate AI model 1330. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 1326 used may be determined based on the type of model structure 1320 and the size of data and the computing resources available in the data layer 1302.

The regularization engine 1328 executes regularization operations. Regularization is a technique that prevents over- and under-fitting of the AI model 1330. Overfitting occurs when the algorithm 1316 is overly complex and too adapted to the training data, which can result in poor performance of the AI model 1330. Underfitting occurs when the algorithm 1316 is unable to recognize even basic patterns from the training data such that it cannot perform well on training data or on validation data. The regularization engine 1328 can apply one or more regularization techniques to fit the algorithm 1316 to the training data properly, which helps constraint the resulting AI model 1330 and improves its ability for generalized application. Examples of regularization techniques include lasso (L1) regularization, ridge (L2) regularization, and elastic (L1 and L2 regularization).

The application layer 1308 describes how the AI system 1300 is used to solve problem or perform tasks. In an example implementation, the application layer 1308 can include the tROAS model 304 or the call tracking platform 604.

Some embodiments may implement one or more of the following solutions, listed in clause-format. The following clauses are supported and further described in the embodiments above and throughout this document.
Solution 1. A method for allocating digital resource, comprising: generating, based on a machine learning model, a predicted feature of a user by inputting a representation of a user profile of the user into the machine learning model, wherein the machine learning model is generated by: receiving, by a processor, user data from a database; generating, by the processor, a first training set by extracting multi-dimensional feature representations from historical online engagement activities of the plurality of sample users; training a machine learning model in a first stage using the first training set to generate initial classification boundaries for user interest prediction; automatically detecting classification errors; constructing a second training dataset based on (e.g., by combining) the first training set with the identified classification errors; and retraining the machine learning model using the second training dataset; and executing a real-time digital resource allocation operation based on the predicted feature of the user. In some embodiments, automatically detecting classification errors may include identifying, from the plurality of sample users, a first subset of users incorrectly classified as interested based on digital engagement metrics; and/or identifying, from the plurality of sample users, a second subset of sample users incorrectly classified as uninterested based on digital engagement metrics.
Solution 2. The method of any one or more solutions disclosed herein, wherein the representation of the user profile comprises a multi-dimensional feature vector for inputting to the machine learning model.
Solution 3. The method of any one or more solutions disclosed herein, further comprising generating the representation of the user profile by pre-processing the user profile.
Solution 4. The method of any one or more solutions disclosed herein, wherein the pre-processing comprises at least one of: vectorizing the user profile by converting categorical features into numerical representations; or scaling numerical features to a normalized range.
Solution 5. The method of any one or more solutions disclosed herein, wherein converting the categorical features comprises using at least one technique of one-hot encoding, label encoding, or learned embeddings.
Solution 6. The method of any one or more solutions disclosed herein, wherein the machine learning model is a tree-based model configured to support non-vectorized inputs.
Solution 7. The method of any one or more solutions disclosed herein, wherein the machine learning model is trained using a gradient boosting technique.
Solution 8. The method of any one or more solutions disclosed herein, wherein the machine learning model comprises at least one base model of a decision tree, a random forest, a gradient-boosted decision tree, a support vector machine (SVM), a logistic regression model, a k-nearest neighbors (k-NN) model, or a naive Bayes classifier.
Solution 9. The method of any one or more solutions disclosed herein, further comprising tracking, via the network interface, an engagement activity of the user subsequent to the real-time digital resource allocation operation.
Solution 10. A method, comprising: obtaining, at a bid adjustments processor, a machine learning model trained to predict bid amounts based on multi-faceted user profiles of sample users; receiving, during an active advertising campaign, information about an available advertisement slot with respect to a prospective user on a webpage, search results page, or in an application; determining, by the bid adjustments processor using the machine learning model, a bid amount for the slot by inputting a representation of a user profile of the prospective user to the machine learning model; and participating in a real-time auction for the slot by transmitting the bid amount to an advertisement platform. In some embodiments, the method is performed in an online real-time advertisement auction.
Solution 11. The method of any one or more solutions disclosed herein, wherein the machine learning model is trained to predict a value the prospective user is expected to generate for a vendor relating to the advertisement slot, and the bid amount relates to the predicted value.
Solution 12. The method of any one or more solutions disclosed herein, wherein the multi-faceted user profiles of the sample users comprise at least of values the sample users have generated for a vendor, duration of the sample users used a service of the vendor, geographic information, a credit history of each of one or more of the sample users, service or product type of the vendor that a sample user used or purchased, or activation or purchase type.
Solution 13. The method of any one or more solutions disclosed herein, wherein determining the bid amount comprises: comparing, by the machine learning model, characteristics of the user profile of the prospective user with characteristics of known high-value customers identified during training of the machine learning model.
Solution 14. The method of any one or more solutions disclosed herein, wherein the machine learning model is configured to classify the prospective user into one of multiple value-based classes, and the bid amount is determined based on the classified value-based class.
Solution 15. The method of any one or more solutions disclosed herein, further comprising: determining no bid amount for a second prospective user by inputting a representation of a user profile of the second prospective user.
Solution 16. The method of any one or more solutions disclosed herein, wherein the prospective user is a first prospective user, the method further comprising: determining, by the bid adjustments processor using the machine learning model, a bid amount for the slot by inputting a representation of a user profile of a second prospective user to the machine learning model, the bid amount for the second prospective user is different from the bid amount for the first prospective user.
Solution 17. The method of any one or more solutions disclosed herein, further comprising: participating in the real-time auction for the slot by transmitting the bid amount for the second prospective user to the advertisement platform.
Solution 18. The method of any one or more solutions disclosed herein, further comprising: tracking customer engagement metrics in response to winning the auction, wherein the engagement metrics comprise at least one of advertisement click-throughs, conversion rates, or post-conversion behaviors.
Solution 19. The method of any one or more solutions disclosed herein, wherein tracking customer engagement metrics comprises: receiving the customer engagement metrics from a vendor database for updating training data used for the machine learning model.
Solution 20. The method of any one or more solutions disclosed herein, further comprising: generating the representation of a user profile of the prospective user by pre-processing the user profile.
Solution 21. The method of any one or more solutions disclosed herein, wherein the pre-processing comprises performing at least one of: vectorizing the user profile by converting categorical features into numerical representations; or scaling numerical features of the user profile to a normalized range.
Solution 22. A method, comprising: obtaining, at a bid adjustments processor, a lookup table and a machine learning model, the lookup table comprising multi-faceted user profiles of sample users, the machine learning model being trained to compare a user profile with the lookup table; receiving, during an active advertising campaign, information about an available advertisement slot with respect to a prospective user on a webpage, search results page, or in an application; determining, by the bid adjustments processor, a bid amount for the slot by comparing, using the machine learning model, a user profile of the prospective user to the lookup table; and participating in a real-time auction for the slot by transmitting the bid amount to an advertisement platform. In some embodiments, the method is performed in an online real-time advertisement auction.
Solution 23. The method of any one or more solutions disclosed herein, wherein the machine learning model and/or the lookup table is iteratively updated.
Solution 24. The method of any one or more solutions disclosed herein, wherein the bid amount for the slot with respect to a prospective user is determined based further on a Targeted Return On Ad Spend (tROAS).
Solution 25. A system, comprising: at least one processor; and memory storing instructions that, when executed by the at least one processor, cause the system to perform the method of any one or more solutions disclosed herein.
Solution 26. A non-transitory computer-readable storage medium storing instructions that, when executed by at least one processor, cause the at least one processor to perform the method of any one or more solutions disclosed herein.

### REMARKS

The systems and methods described herein provide several technical improvements to digital advertising platforms. In terms of resource efficiency, the technology reduces unnecessary bid processing by precisely targeting high-value prospects and minimizing network bandwidth consumption by avoiding bidding on low-value opportunities. For example, by filtering out low-value prospects early in the process, the system significantly reduces the number of bid computations and network transactions required. The system optimizes server load by implementing efficient prediction models and streamlines data processing through intelligent feature extraction and representation techniques, such as dimensionality reduction and efficient data structures for rapid lookup.

The technology also delivers significant improvements in prediction accuracy. The multi-stage or iteratively training process specifically addresses classification errors, while continuous feedback loops incorporate actual performance data to refine predictions. When implemented using machine learning models, the system employs efficient model architectures that balance prediction accuracy with computational cost. For lookup table implementations, the system employs a data-driven approach to select which parameters to include in the table. The selection process analyzes historical customer data to identify parameters that have strong correlations with customer value and retention. For example, analysis of historical data might reveal that certain combinations of parameters—such as credit score ranges, geographical locations, and service package selections—are particularly predictive of customer lifetime value.

Real-time performance is another technical benefit. The system enables instant bid amount decisions crucial for time-sensitive ad auctions while supporting high-volume parallel processing of bid requests. The implementation includes techniques such as caching frequently accessed data, parallel processing of multiple bid requests, and optimized database queries. Through these optimizations, the system maintains consistently fast response times during live campaigns, typically generating bid decisions within milliseconds as required by programmatic advertising platforms.

The technology provides robust scalability benefits through specific technical implementations. The system may employ distributed processing architectures to handle large volumes of user profiles and bid requests efficiently. It may use partitioned data storage and load balancing techniques to manage growing data volumes. The implementation includes efficient data indexing strategies for quick access to relevant user profiles and bid amounts. Memory-efficient data structures and compression techniques help manage the growing complexity of user profiles while maintaining fast access times. These technical solutions ensure the system can scale effectively as advertising campaigns grow, handling increased bid request volumes without degrading performance.

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in an embodiment” (or the like) in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

As used herein, the term “and/or” when used in the phrase “A and/or B” means “A, or B, or both A and B.” A similar manner of interpretation applies to the term “and/or” when used in a list of more than two terms.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A method for allocating digital resource, comprising:
generating, based on a machine learning model, a predicted feature of a user by inputting a representation of a user profile of the user into the machine learning model, wherein the machine learning model is generated by:
receiving, by a processor, user data from a database;
generating, by the processor, a first training set by extracting multi-dimensional feature representations from historical online engagement activities of a plurality of sample users;
training a machine learning model in a first stage using the first training set to generate initial classification boundaries for user interest prediction;
automatically detecting classification errors by:
identifying, from the plurality of sample users, a first subset of users incorrectly classified as interested based on digital engagement metrics;
identifying, from the plurality of sample users, a second subset of sample users incorrectly classified as uninterested based on digital engagement metrics;
constructing a second training dataset based on the first training set with the identified classification errors; and
retraining the machine learning model using the second training dataset; and
executing a real-time digital resource allocation operation based on the predicted feature of the user.

2. The method of claim 1, wherein the representation of the user profile comprises a multi-dimensional feature vector for inputting to the machine learning model.

3. The method of claim 1, further comprising generating the representation of the user profile by pre-processing the user profile.

4. The method of claim 3, wherein the pre-processing comprises at least one of:
vectorizing the user profile by converting categorical features into numerical representations; or
scaling numerical features to a normalized range.

5. The method of claim 4, wherein converting the categorical features comprises using at least one technique of one-hot encoding, label encoding, or learned embeddings.

6. The method of claim 1, wherein the machine learning model is a tree-based model configured to support non-vectorized inputs.

7. The method of claim 1, wherein the machine learning model is trained using a gradient boosting technique.

8. The method of claim 1, wherein the machine learning model comprises at least one base model of a decision tree, a random forest, a gradient-boosted decision tree, a support vector machine (SVM), a logistic regression model, a k-nearest neighbors (k-NN) model, or a naive Bayes classifier.

9. The method of claim 1, further comprising tracking an engagement activity of the user subsequent to the real-time digital resource allocation operation.

10. A system, comprising: at least one processor; and memory storing instructions that, when executed by the at least one processor, cause the system to perform operations including:
generating, based on a machine learning model, a predicted feature of a user by inputting a representation of a user profile of the user into the machine learning model, wherein the machine learning model is generated by:
receiving user data from a database;
generating a first training set by extracting multi-dimensional feature representations from historical online engagement activities of a plurality of sample users;
training a machine learning model in a first stage using the first training set to generate initial classification boundaries for user interest prediction;
automatically detecting classification errors by performing at least one of:
identifying, from the plurality of sample users, a first subset of users incorrectly classified as interested based on digital engagement metrics; or
identifying, from the plurality of sample users, a second subset of sample users incorrectly classified as uninterested based on digital engagement metrics;
constructing a second training dataset based on the first training set with the identified classification errors; and
retraining the machine learning model using the second training dataset; and
executing a real-time digital resource allocation operation based on the predicted feature of the user.

11. The system of claim 10, wherein the representation of the user profile comprises a multi-dimensional feature vector for inputting to the machine learning model.

12. The system of claim 10, wherein the instructions further cause the system to generate the representation of the user profile by pre-processing the user profile.

13. The system of claim 12, wherein the pre-processing comprises at least one of:
vectorizing the user profile by converting categorical features into numerical representations; or
scaling numerical features of the user profile to a normalized range.

14. The system of claim 10, wherein the machine learning model is a tree-based model configured to support non-vectorized inputs.

15. A non-transitory computer-readable storage medium storing instructions that, when executed by at least one processor, cause the at least one processor to perform operations including:
generating, based on a machine learning model, a predicted feature of a user by inputting a representation of a user profile of the user into the machine learning model, wherein the machine learning model is generated by:
receiving user data of a plurality of sample users from a database;
generating a first training set by extracting multi-dimensional feature representations from historical online engagement activities of the plurality of sample users;
training a machine learning model in a first stage using the first training set to generate initial classification boundaries for user interest prediction;
automatically detecting classification errors by performing at least one of:
identifying, from the plurality of sample users, a first subset of users incorrectly classified as interested based on digital engagement metrics; or
identifying, from the plurality of sample users, a second subset of sample users incorrectly classified as uninterested based on digital engagement metrics;
constructing a second training dataset based on the first training set with the identified classification errors; and
retraining the machine learning model using the second training dataset; and
executing a real-time digital resource allocation operation based on the predicted feature of the user.

16. The non-transitory computer-readable storage medium of claim 15, wherein the representation of the user profile comprises a multi-dimensional feature vector for inputting to the machine learning model.

17. The non-transitory computer-readable storage medium of claim 15, wherein the instructions further cause the processor to generate the representation of the user profile by pre-processing the user profile.

18. The non-transitory computer-readable storage medium of claim 17, wherein the pre-processing comprises at least one of:
vectorizing the user profile by converting categorical features into numerical representations; or
scaling numerical features of the user profile to a normalized range.

19. The non-transitory computer-readable storage medium of claim 15, wherein the machine learning model is trained using a gradient boosting technique.

20. The non-transitory computer-readable storage medium of claim 15, wherein the machine learning model comprises at least one base model of a decision tree, a random forest, a gradient-boosted decision tree, a support vector machine (SVM), a logistic regression model, a k-nearest neighbors (k-NN) model, or a naive Bayes classifier.
